(19) United States
(12) Patent Application Publication
(10) Pub. No.: US 2025/0005507 A1
(43) Pub. Date: Jan. 2, 2025

(54) LOCATING TEMPORARY DISTRIBUTION LANES ON A ROAD FOR TRANSSHIPMENT

(71) Applicant: International Business Machines Corporation, Armonk, NY (US)

(72) Inventors: Sanehiro Furuichi, Setagaya-ku (JP); Yohkichi Sasatani, Yokohama City (JP); Tooru Tabara, Yokohama-shi (JP); Hirotaka Matsumoto, Zama (JP); Akira Saito, Ichikawa-shi (JP); Tsend Ochir Bat Ulzii, Edogawa-ku (JP); Takeshi Watanabe, Kawasaki (JP)

(21) Appl. No.: 18/343,823

(22) Filed: Jun. 29, 2023

(51) Int. Cl. G06Q 10/0835; G06Q 10/0832

(52) U.S. Cl. CPC G06Q 10/08355; G06Q 10/0832

(57) ABSTRACT

Systems, computer-implemented methods, and computer program products to facilitate locating temporary distribution lanes on a road for transshipment are provided. According to an embodiment, a system can comprise a processor that executes components stored in memory. The computer executable components can comprise a vehicle network component that can determine one or more vehicles for package delivery from a network of connected vehicles based on delivery destination information. The computer executable components can comprise a lane definition component that can define one or more temporary lanes based on predicted travel positions from the delivery destination information for the one or more vehicles. The computer executable components can comprise a transshipment component that can perform transshipment of packages between the one or more vehicles within the one or more temporary lanes.

### BACKGROUND

Temporary lanes can be used for the efficient distribution of packages on a road via a vehicle network including one or more connected vehicles. Further, one or more temporary lanes can be determined based on delivery destination information to facilitate the transshipment of one or more packages to one or mode nodes of the physical internet. The subject disclosure relates to dynamically locating temporary distribution lanes to facilitate transshipment between vehicles.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate locating temporary distribution lanes on a road via physical internet are provided.

According to an embodiment, a system can comprise a processor that executes computer executable components stored in memory. The computer executable components can comprise a vehicle network component that can determine one or more vehicles for package delivery from a network of connected vehicles based on delivery destination information. The computer executable components can comprise a lane definition component that can define one or more temporary lanes based on predicted travel positions from the delivery destination information for the one or more vehicles. Additionally, the computer executable components can comprise a transshipment component that can perform transshipment of packages between the one or more vehicles within the one or more temporary lanes. Additionally, one or more general vehicles can be prohibited from traveling in the one or more temporary lanes, and the one or more temporary lanes can be released for general vehicle travel upon completing the transshipment.

According to an embodiment, a computer implemented method for locating distribution lanes on a road for transshipment, can comprise determining, by a device operatively coupled to a processor, one or more vehicles for package delivery from a network of connected vehicles based on delivery destination information. Additionally, the computer implemented method can comprise defining, by the device, one or more temporary lanes based on predicted travel positions from the delivery destination information for the one or more vehicles. The computer implemented method can further comprise performing, by the device, transshipment of packages between the one or more vehicles within the one or more temporary lanes.

According to an additional embodiment, the computer implemented method can comprise prohibiting, by the device, one or more general vehicles from traveling in the one or more temporary lanes. The computer implemented method can comprise releasing, by the device, the one or more temporary lanes for general vehicle travel upon completing the transshipment.

According to an embodiment, a computer program product for locating distribution lanes on a road for transshipment can comprise a computer readable storage medium having program instructions embodied therewith, the program instructions can be executable by a processor to cause the processor to determine one or more vehicles for package delivery from a network of connected vehicles based on delivery destination information. Additionally, the program instructions can be executable by a processor to cause the processor to define one or more temporary lanes based on predicted travel positions from the delivery destination information for the one or more vehicles.

Further, the program instructions can be executable by a processor to cause the processor to perform transshipment of packages between the one or more vehicles within the one or more temporary lanes. The program instructions can be executable by a processor to cause the processor to prohibit one or more general vehicles from traveling in the one or more temporary lanes. Also, the program instructions can be executable by a processor to cause the processor to release the one or more temporary lanes for general vehicle travel upon completing the transshipment.

### DESCRIPTION OF THE DRAWINGS

FIG. 1 illustrates a block diagram of an example, non-limiting system that can facilitate locating temporary distribution lanes on a road for transshipment, in accordance with one or more embodiments described herein.

FIG. 2A illustrates a diagram of an example, non-limiting system that can facilitate locating temporary distribution lanes on a road for transshipment, in accordance with one or more embodiments described herein.

FIG. 2B illustrates a flow diagram of an example, non-limiting computer-implemented method that can facilitate locating temporary distribution lanes on a road for transshipment, in accordance with one or more embodiments described herein.

FIG. 3 illustrates a block diagram of an example, non-limiting system that can facilitate locating temporary distribution lanes on a road for transshipment, in accordance with one or more embodiments described herein.

FIGS. 4A and 4B illustrate block diagrams of an example, non-limiting system that can facilitate locating temporary distribution lanes on a road for transshipment, in accordance with one or more embodiments described herein.

FIGS. 5A and 5B illustrate block diagrams of an example, non-limiting system that can facilitate locating temporary distribution lanes on a road for transshipment, in accordance with one or more embodiments described herein.

FIGS. 6A and 6B illustrate block diagrams of an example, non-limiting system that can facilitate locating temporary distribution lanes on a road for transshipment, in accordance with one or more embodiments described herein.

FIG. 7 illustrates block diagrams of an example, non-limiting system that can facilitate locating temporary distribution lanes on a road for transshipment, in accordance with one or more embodiments described herein.

FIG. 8 illustrates block diagrams of an example, non-limiting system that can facilitate locating temporary distribution lanes on a road for transshipment, in accordance with one or more embodiments described herein.

FIG. 9 illustrates a block diagram of an example, non-limiting system that can facilitate locating temporary distribution lanes on a road for transshipment of vehicles and packages, in accordance with one or more embodiments described herein.

FIG. 10 illustrates a block diagram of an example, non-limiting system that can facilitate locating temporary distribution lanes on a road for transshipment via one or more of a variety of autonomous vehicles, in accordance with one or more embodiments described herein.

FIG. 11 illustrates a flow diagram of an example, non-limiting computer-implemented method that can facilitate locating temporary distribution lanes on a road for transshipment, in accordance with one or more embodiments described herein.

FIG. 12 illustrates a flow diagram continued from FIG. 11 of an example, non-limiting computer-implemented method that can facilitate locating temporary distribution lanes on a road for transshipment, in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The Physical Internet (PI) has emerged as a promising solution to revolutionize the way packages are transferred and transported. Inspired by the efficiency and flexibility of Internet packet routing, the Physical Internet presents a paradigm shift from conventional logistics operations. Instead of transporting packages directly from their origin to the final destination, packages can be transshipped at PI nodes located across various locations. By leveraging the cooperative efforts of multiple operators and sharing resources, including warehouses and transportation vehicles, the Physical Internet aims to maximize loading efficiency during package transportation.

One of the core tenets of the Physical Internet framework is the concept of transshipment at strategically positioned PI nodes. Similar to how Internet packets are routed through various nodes before reaching their destination, packages in the Physical Internet traverse a network of interconnected nodes, seamlessly changing operators at each transshipment point. This dynamic and collaborative approach not only enhances the flexibility and efficiency of package transfers but also opens up new opportunities for optimization in logistics operations.

To realize the full potential of the Physical Internet, the framework can be able to cater to diverse transportation demands, ranging from small and medium-sized shipments to large-scale cargo. In sparsely inhabited regions such as rural areas, where transportation demands are limited, the cost-efficiency of establishing new PI nodes becomes questionable. Consequently, logistics operations often find themselves faced with the need to transport packages over long distances from distant locations, hampering the overall efficiency of the system.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In some embodiments, the present disclosure can be implemented to produce a solution to the problems described above in the form of systems, computer-implemented methods, and/or computer program products that can further facilitate using temporary lanes for the transshipment of packages.

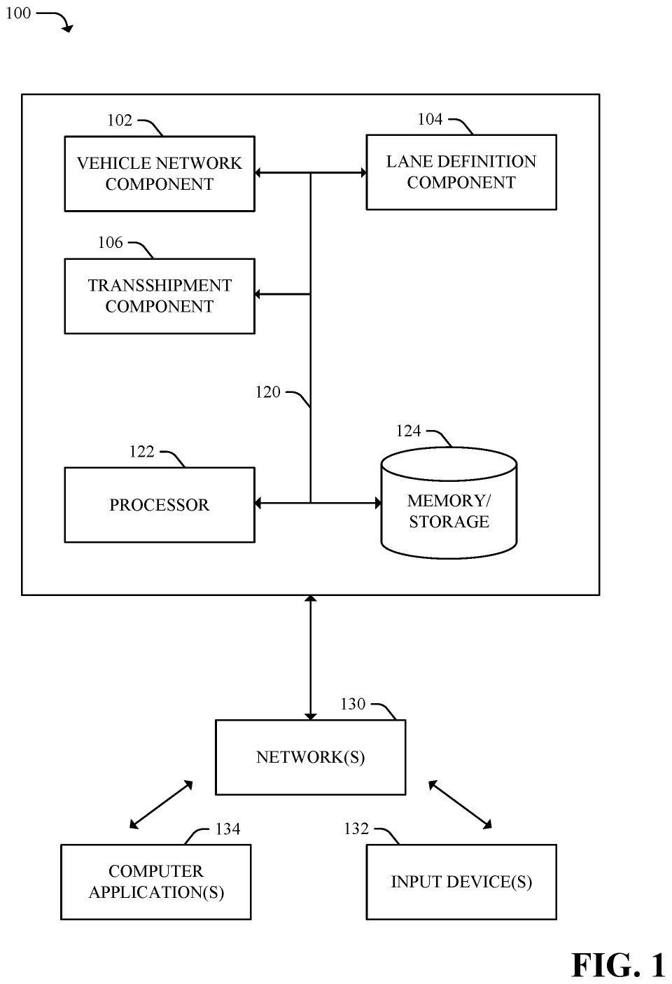

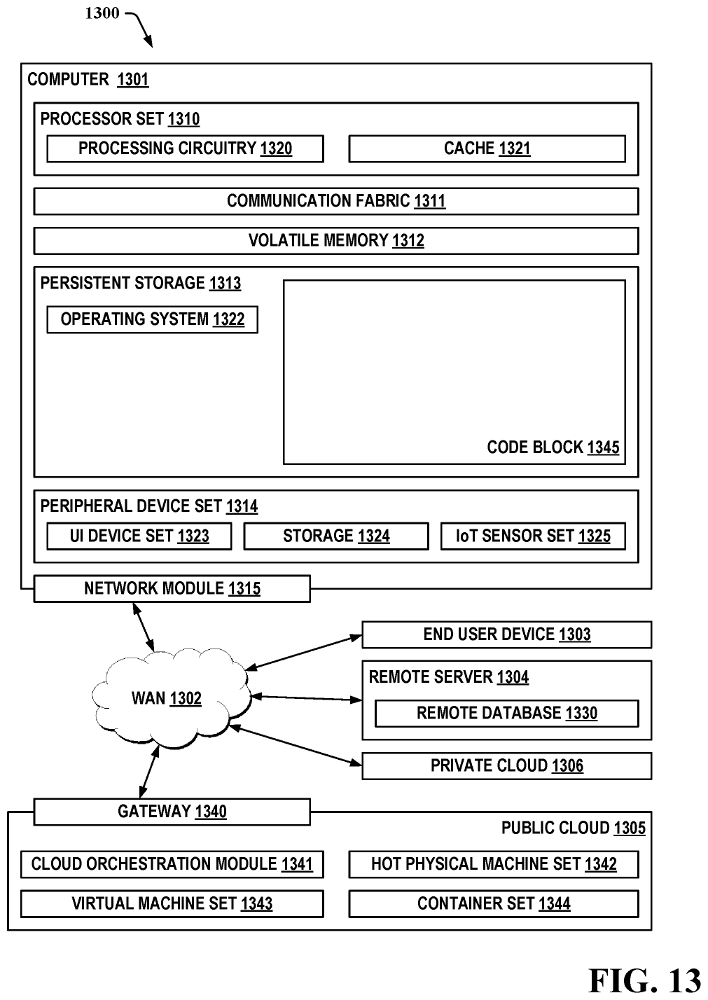

FIG. 1 illustrates a block diagram of an example, non-limiting temporary lane transshipment system 100 that comprises a vehicle network component 102, a lane definition component 104, and a transshipment component 106. The vehicle network component 102 can determine one or more vehicles for package delivery from a network of connected vehicles based on delivery destination information. The lane definition component 104 can define one or more temporary lanes based on predicted travel positions from the delivery destination information for the one or more vehicles. The transshipment component 106 can perform transshipment (e.g., transshipment can include the physical exchange of packages between one or more vehicles in any manner) of packages between the one or more vehicles within the one or more temporary lanes. One or more general vehicles can be prohibited from traveling in the one or more temporary lanes, and the one or more temporary lanes can be released for general vehicle travel upon completing the transshipment. Repetitive description of like elements employed in other embodiments described herein is omitted for sake of brevity. Aspects of systems (e.g., the temporary lane transshipment system 100 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines (e.g., computers, computing devices, virtual machines, a combination thereof, and/or the like) can cause the machines to perform the operations described. Further, the vehicle network component 102, the lane definition component 104, and the transshipment component 106 can be associated with a computing environment 1300 (FIG. 13).

Discussion first turns briefly to system bus 120, processor 122, and memory 124 of the temporary lane transshipment system 100. For example, in one or more embodiments, the temporary lane transshipment system 100 can comprise processor 122 (e.g., computer processing unit, microprocessor, classical processor, and/or like processor). In one or more embodiments, a component associated with temporary lane transshipment system 100, as described herein with or without reference to the one or more figures of the one or more embodiments, can comprise one or more computer and/or machine readable, writable and/or executable components and/or instructions that can be executed by processor 122 to enable performance of one or more processes defined by such component(s) and/or instruction(s).

In one or more embodiments, the temporary lane transshipment system 100 can comprise a computer-readable memory (e.g., memory 124) that can be operably connected to the processor 122. Memory 124 can store computer-executable instructions that, upon execution by processor 122, can cause processor 122 and/or one or more other components of the temporary lane transshipment system 100 (e.g., the vehicle network component 102, the lane definition component 104, and the transshipment component 106) to perform one or more actions. In one or more embodiments, memory 124 can store computer-executable components (e.g., the vehicle network component 102, the lane definition component 104, and the transshipment component 106).

With embodiments, the temporary lane transshipment system 100 and/or a component thereof as described herein, can be communicatively, electrically, operatively, optically and/or otherwise coupled to one another via bus 120. Bus 120 can comprise one or more of a memory bus, memory controller, peripheral bus, external bus, local bus, and/or another type of bus that can employ one or more bus architectures. One or more of these examples of bus 120 can be employed. In one or more embodiments, the temporary lane transshipment system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of the temporary lane transshipment system 100 can reside in the cloud, and/or can reside locally in a local computing environment (e.g., at a specified location(s)). In examples, the temporary lane transshipment system 100 can be connected with the bus 120, one or more input devices 132, and one or more computer applications 134, which can be associated with cloud computing environment 1300 (FIG. 13).

In addition to the processor 122 and/or memory 124 described above, the temporary lane transshipment system 100 can comprise one or more computer and/or machine readable, writable and/or executable components and/or instructions that, when executed by processor 122, can enable performance of one or more operations defined by such component(s) and/or instruction(s). The temporary lane transshipment system 100 can be associated with, such as accessible via, a computing environment 1300 described below with reference to FIG. 13. For example, the temporary lane transshipment system 100 can be associated with a computing environment 1300 such that aspects of processing can be distributed between the temporary lane transshipment system 100 and the computing environment 1300.

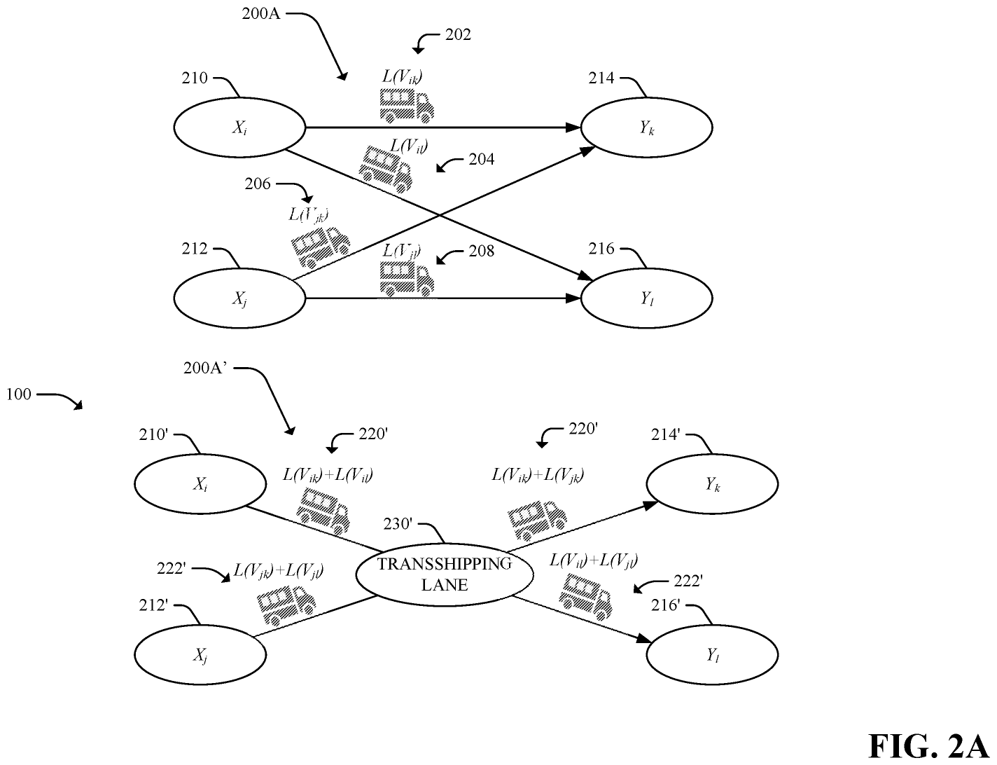

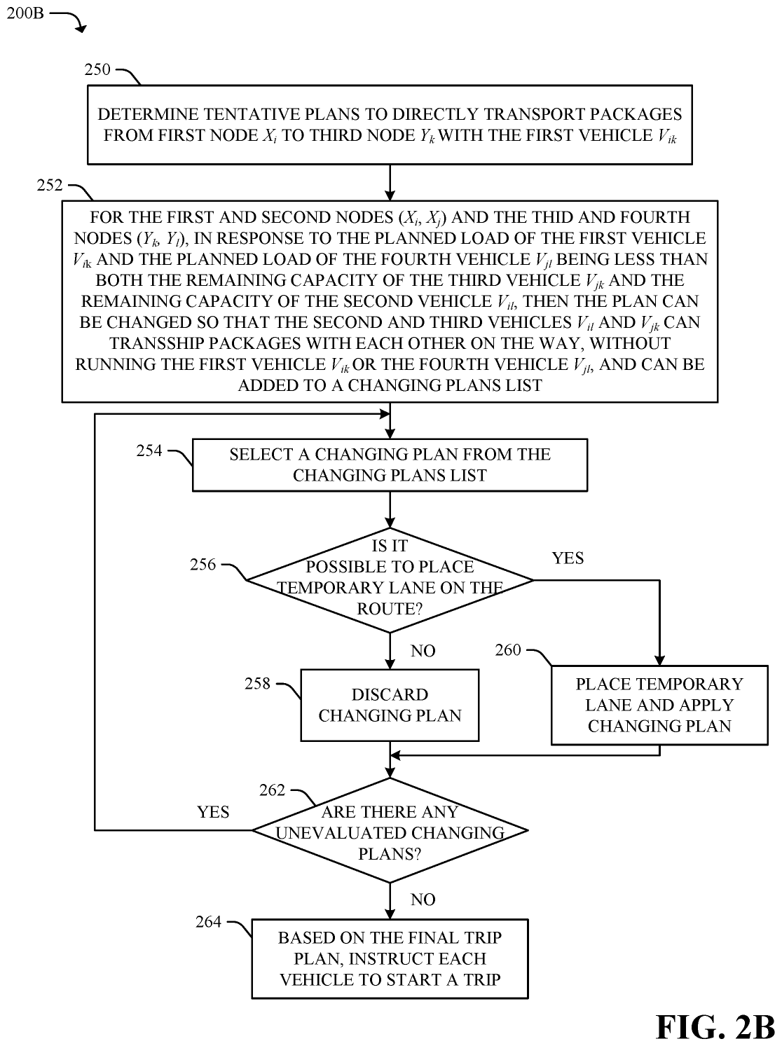

With embodiments, such as generally illustrated in FIG. 2A, a vehicle network 200A can comprise a first vehicle 202, a second vehicle 204, a third vehicle 206, and a fourth vehicle 208 to deliver one or more packages to a variety of locations (e.g., nodes). For example and without limitation the vehicle network 200A can be configured to transport one or more packages from a first node 210 or a second node 212, to a third node 214 or a fourth node 216. The first node 210, the second node 212, the third node 214, and/or the fourth node 216 can correspond with physical locations, other vehicle locations, and/or lanes on a road.

For example and without limitation, as shown in the first portion of FIG. 2A. (e.g., in embodiments where transshipping lanes are not used), the first vehicle 202 and the second vehicle 204 can depart from the first node 210 and can deliver one or more packages to the third node 214 or the fourth node 216. Similarly, the third vehicle 206 and the fourth vehicle 208 can depart from the second node 212 and can deliver one or more packages to the third node 214 or the fourth node 216. It can be desirable to minimize the number of vehicles and/or the number of routes (e.g., the distances traveled on one or more routes) used to ship the one or more packages. Further, instead of shipping the one or more packages via two vehicles from the first node 210, a single vehicle (e.g., a first vehicle 220′) can travel from the first node 210′ to a temporary lane 230′ (e.g., a transshipping lane), as shown in the second portion of FIG. 2A. In a similar manner, instead of shipping the one or more packages from two vehicles from the second node 212′, a single vehicle (e.g., a second vehicle 222′) can travel from the second node 212′ to the temporary lane 230′. The first vehicle 220′ and the second vehicle 222′ can occupy the temporary lane 230′ such that one or more packages can be exchanged between (e.g., providing for streamlined package transportation and delivery).

As will be demonstrated further, such as in FIG. 2B, the system 100 can determine whether a vehicle can receive additional packages during transshipment and/or whether the vehicle can receive additional routes or destinations for the additional packages (e.g., based on the delivery destination information of the additional packages).

With examples, the lane definition component 104 can define one or more temporary lanes 230′ based on the delivery destination information for the first vehicle 220′ and the second vehicle 222′, such that the first vehicle 220′ and the second vehicle 222′ can exchange packages. The lane definition component 104 can determine one or more portions of a road (e.g., or parking lot, or other location for a vehicle to wait) where a first planned route of the first vehicle 220′ overlaps/intersects with a second planned route of a second vehicle 222′. The lane definition component 104 can determine/calculate an optimal location for a temporary lane 230′ where transshipping can be conducted between the first vehicle 220′ and the second vehicle 222′. For example and without limitation, the temporary lane 230′ can be an exclusive lane where other vehicles (e.g., vehicles not associated with the vehicle network 200A′ of the system 100) are not permitted to travel within. The temporary lane 230′ (e.g., the transshipping lane) can be dynamically placed on the road such that the location can be updated for one or more a variety of logistical factors (e.g., such as traffic updates, package shipping updates, vehicle routing updates, weather updates, etc.).

In embodiments, the system 100 (e.g., the vehicle network component 102, the lane definition component 104, or the transshipment component 106) can determine the vehicle network from one or more vehicles based on delivery destination information. For example and without limitation, the delivery destination information can include predicted travel positions for any vehicles in the vehicle network. The delivery destination information can additionally include package planned load information (e.g., L) and vehicle remaining capacity information (e.g., C) to aid in facilitating determining one or more temporary lanes for transshipment of packages. The planned load information can indicate a planned load of the associated vehicle (e.g., indicating an area of the vehicle that packages are stored for delivery), and the vehicle remaining capacity information can indicate the total remaining package capacity for the associated vehicle. As shown in the first portion of FIG. 2A, the first node 210 can be represented by Xᵢ and the second node 212 can be represented by Xⱼ (e.g., origin nodes). The third node 214 can be represented by Yₖ and the fourth node 216 can be represented by Yₗ (e.g., destination nodes). Additionally, a planned load of the first vehicle 202 can be represented by L(Vᵢₖ); a planned load of the second vehicle 204 can be represented by L(Vᵢₗ); a planned load of the third vehicle 206 can be represented by L(Vᵢₖ); and a planned load of the fourth vehicle 208 can be represented by L(Vⱼₗ). Similarly, the remaining capacity of the first vehicle 202 can be represented by C(Vᵢₖ); the remining capacity of the second vehicle 204 can be represented by C(Vᵢₗ); the remining capacity of the third vehicle 206 can be represented by C(Vᵢₖ); and the remaining capacity of the fourth vehicle 208 can be represented by C(Vⱼₗ).

In response to the system 100 determining that both the planned load of the first vehicle 202 and the planned load of the fourth vehicle 208 are less than both the remaining capacity of the second vehicle 204 and the remaining capacity of the third vehicle 206, a temporary lane (e.g., transshipping lane) 230′ can be determined/generated such that the second vehicle 204 (e.g., the first vehicle 220′) and the third vehicle 206 (e.g., the second vehicle 222′) can exchange packages therebetween (e.g., via transshipping) so the first vehicle 202 and the fourth vehicle 208 can be removed from the shipping process, as demonstrated in the second portion of FIG. 2A. In examples, the first vehicle 220′ can include a planned load for both of the third node 214′ and the fourth node 216′ (e.g., L(Vᵢₖ)+L(Vᵢₗ)) and the second vehicle 222′ can include a planned load for both of the third node 214′ and the fourth node 216′ (e.g., L(Vᵢₖ)+L(Vᵢₗ)). In response to both vehicles 220′, 222′ occupying the temporary lane 230′, planned loads can be exchanged between the first vehicle 220′ and the second vehicle 222′ such that, after transshipping, the first vehicle 220′ includes planned loads for the third node 214′ from both the first node 210′ and the second node 212′ (e.g., L(Vᵢₖ)+L(Vᵢₖ)). Further, after transshipping, planned loads can exchanged such that the second vehicle 222′ includes planned loads for the fourth node 216′ from both the first node 210′ and the second node 212′ (e.g., L(Vᵢₗ)+L(Vⱼₗ)).

Further, as can be illustrated in FIG. 2B, at 250 a computer implemented method 200B of transshipping packages between vehicles can comprise determining, by a device (e.g., the vehicle network component 102, the lane definition component 104, and the transshipment component 104) operatively coupled to a processor, tentative plans to directly transport packages from the first node 210 to the third node 214 via the first vehicle 220′. Additionally, at 252, the computer implemented method 200B can comprise, for the first and second nodes 210, 212 and the third and fourth nodes 214, 216, in response to the planned load of the first vehicle 202 and the planned load of the fourth vehicle 208 being less than the remaining capacity of the third vehicle 206 and the remaining capacity of the second vehicle 204, the plan (e.g., navigation plan) can be changed such that the second vehicle 204 and the third vehicle 206 can transship packages with each other on the way (e.g., while driving or idle) without running the first vehicle 202 or the fourth vehicle 208 (e.g., which changed plans can be added to a changing plans list).

At 254, the computer implemented method 200B can further comprise selecting, by a device (e.g., the vehicle network component 102, the lane definition component 104, and the transshipment component 104) operatively coupled to a processor, a changing plan from the changing plans list.

At 256, the computer implemented method 200B can comprise determining, by a device (e.g., the vehicle network component 102, the lane definition component 104, and the transshipment component 104) operatively coupled to a processor, if it is possible to place a temporary lane on the route (e.g., a route corresponding with the selected changing plan from the changing plans list). At 258, in response to a determination that it is not possible to place the temporary lane on the route, the changing plan can be discarded. Alternatively, at 260, in response to a determination that it can be possible to place a temporary lane on the route, a temporary lane can be placed and a changing plan can be applied.

At 262, the computer implemented method 200B can comprise determining, by a device (e.g., the vehicle network component 102, the lane definition component 104, and the transshipment component 106) operatively coupled to a processor, if there are any unevaluated changing plans. In response to a determination that not all changing plans have been evaluated, the computer implemented method 200B can comprise, again, selecting a changing plan (e.g., a different changing plan) from the changing plans list. Further, in response to a determination that all changing plans have been evaluated, at 264, the computer implemented method 200B can comprise instructing, by a device (e.g., the vehicle network component 102, the lane definition component 104, and the transshipment component 104) operatively coupled to a processor, each vehicle (based on the final trip plan) to start a trip according to the related changing plan from the changing plans list.

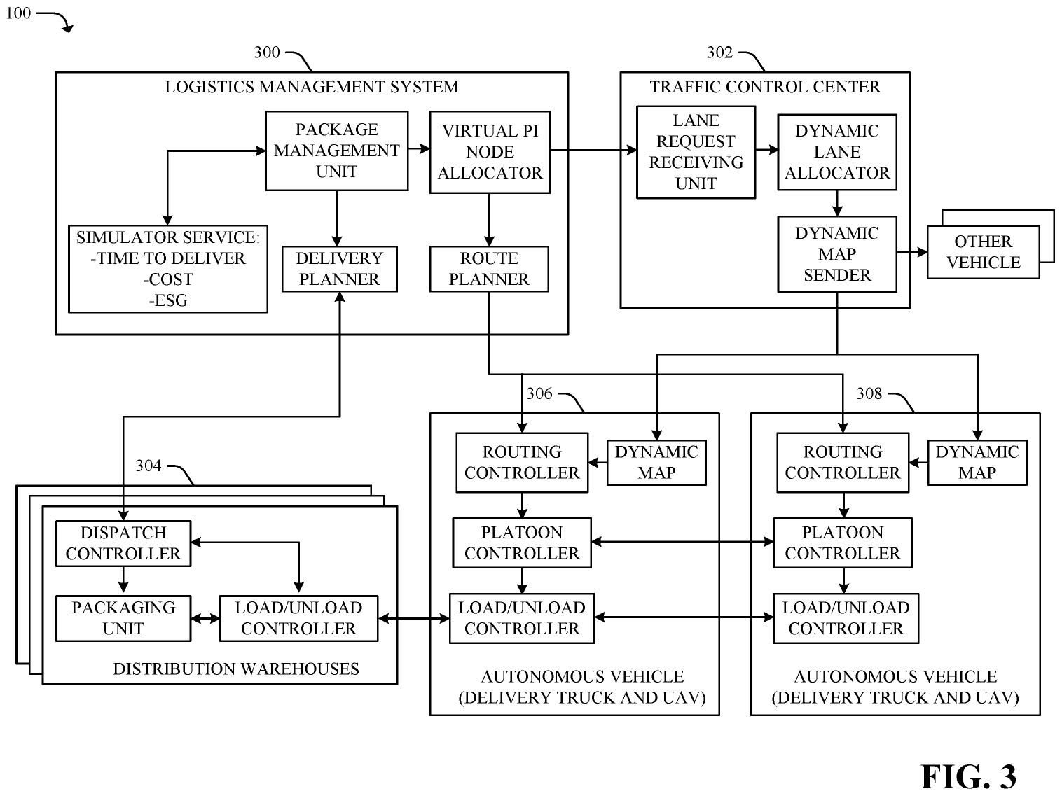

With embodiments, such as generally illustrated in FIG. 3, the temporary lane transshipment system 100 can be connected with one or more of a variety of other systems, vehicles, centers, and/or warehouses. For example and without limitation, the system 100 can be connected (e.g., such as to communicate and/or transfer/receive information) with a logistics management system 300, a traffic control center 302, one or more distribution warehouses 304, and one or more autonomous vehicles 306, 308. The traffic control center 302 can include a lane request receiving unit, a dynamic lane allocator, and/or a dynamic map sender. The one or more distribution warehouses 304 can include a dispatch controller, a packaging unit, and/or a load/unload controller. The one or more vehicles 306, 308 can include a routing controller, a dynamic map, a platoon controller, and/or a load/unload controller. Further, the logistics management system 300 can include a package management unit, a virtual physical internet node allocator, a route planner, a delivery planner, and/or a simulator service. Additionally, the logistics management system 300 can decide how and where the one or more temporary lanes 230 can be located for transshipping of packages by communicating with the traffic control center 302 and with the distribution warehouses 304. Communication between the logistics management system 300 and the one or more distribution warehouses 304 can facilitate selecting packages and/or vehicles of the vehicle network to be exchanged.

The one or more vehicles 306, 308 of the vehicle network can be autonomous vehicles, delivery trucks, and/or unmanned arial vehicles (UAVs) of any level of autonomy. The one or more vehicles 306, 308 can include a load/unload controller to facilitate an exchange of packages during transshipping. In response to instructions from the logistics management system 300 (e.g., to the routing controllers), the one or more vehicles can be selected so that the vehicle can begin to travel towards a temporary lane 230 (e.g., as determined by the lane definition component). By creating a platoon with other vehicles (e.g., such as in a side-by-side or front-to-back arrangement), one or more packages can be exchanged between the one or more vehicles within the temporary lane 230. After package exchange is completed, the temporary lane 230 can be removed such that the general public can travel within the previously-existing temporary lane 230 (e.g., the transshipping lane).

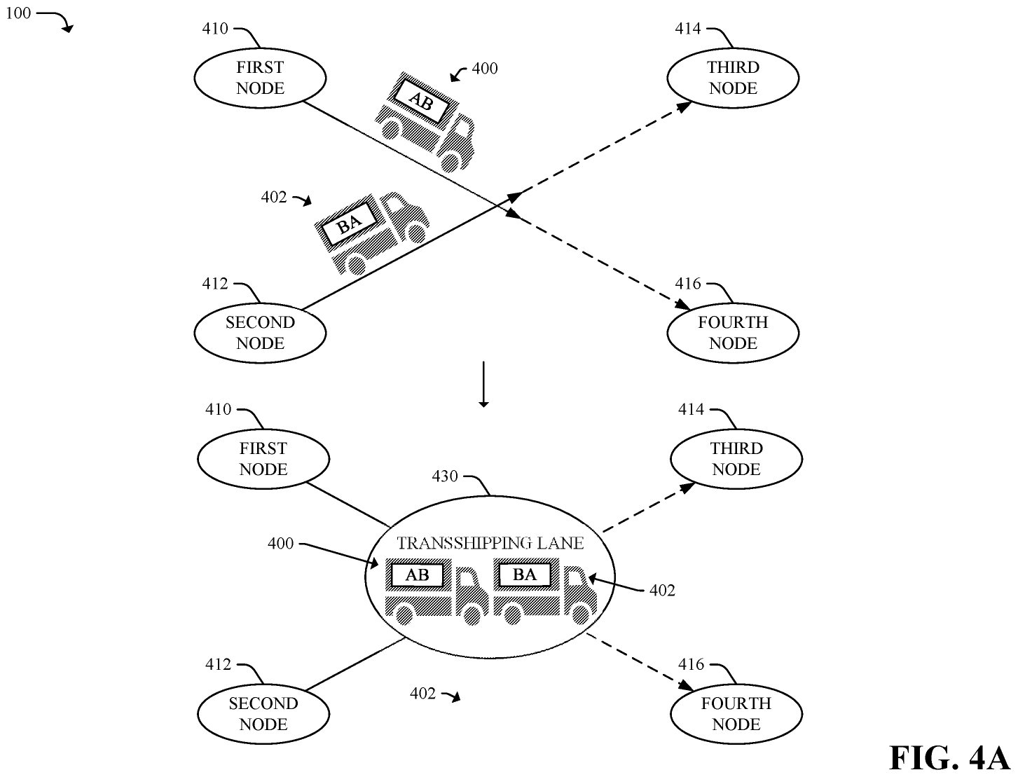

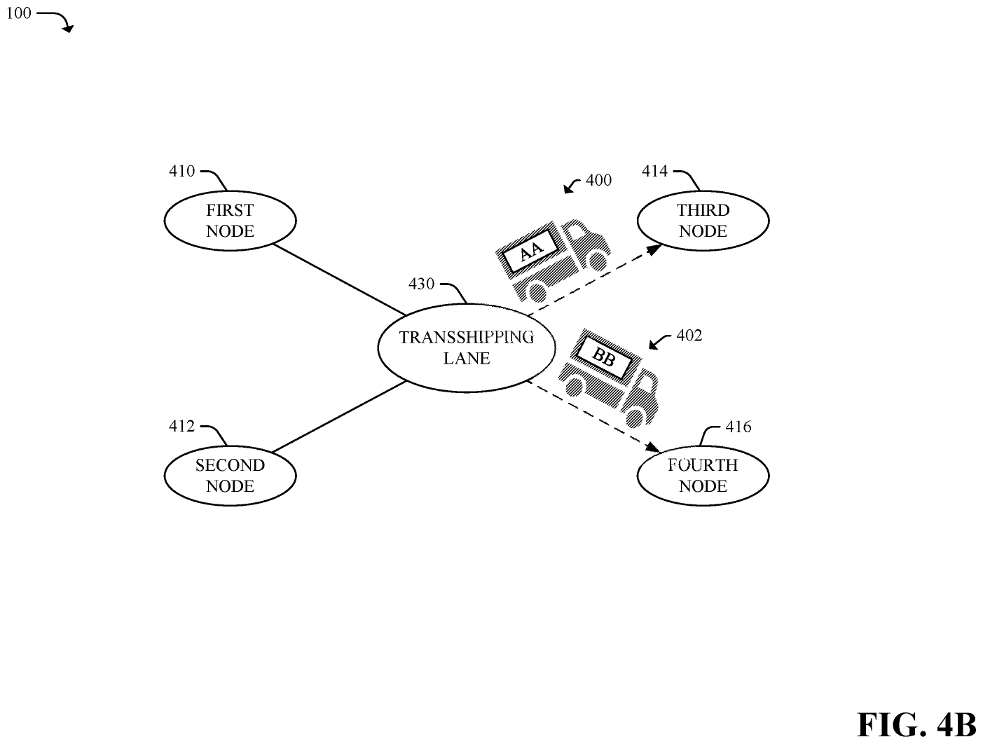

In embodiments, FIGS. 4A and 4B generally illustrate an embodiment of the temporary lane transshipment system 100. The vehicle network can include a first vehicle 400 and a second vehicle 402. The first vehicle 400 can depart from a first node 410, and the second vehicle 402 can depart from a second node 412. The first vehicle 400 can include one or more packages that correspond with destinations at a third node 414 and a fourth node 416. In a similar manner, the second vehicle 402 can include one or more packages that correspond with destinations at the third node 414 (e.g., “A” packages) and the fourth node 416 (e.g., “B” packages). The third node 414 and the fourth node 416 can correspond to one or more of a variety of locations (e.g., final destinations, temporary destinations, physical locations on the road, temporary locations on other vehicles, etc.).

Turning to FIG. 4B, the transshipment component 106 can exchange the one or more packages of the first vehicle 400 with the one or more packages of the second vehicle 402 such that the first vehicle 400 includes packages with destinations at the third node 414 (e.g., “A” packages) and the second vehicle 402 includes packages with destinations at the fourth node 416 (e.g., “B” packages). The lane definition component 104 can define one or more temporary lanes 230 based on predicted travel positions from delivery destination information of the first vehicle 400 and the second vehicle 402 (e.g., and corresponding packages on the vehicle). The one or more packages can be exchanged between the first vehicle 400 and the second vehicle 402 in one or more of a variety of manners. For example and without limitation, the first vehicle 400 and the second vehicle 402 can exchange one or more packages while the first vehicle 400 and the second vehicle 402 are parked or moving. In response to completing the transshipment, the first vehicle 400 can depart from the temporary lane 230 to the third node 414 to unload the one or more packages at the third node 414; the second vehicle 402 can depart from the temporary lane 230 to the fourth node 416 to unload one or more packages at the fourth node 416; and the lane definition component 104 or the transshipment component 106 can remove the temporary lane 230 from the road such that travel is no longer excluded (e.g., where the general vehicles including the general public can be prohibited from traveling) within the temporary lane 230.

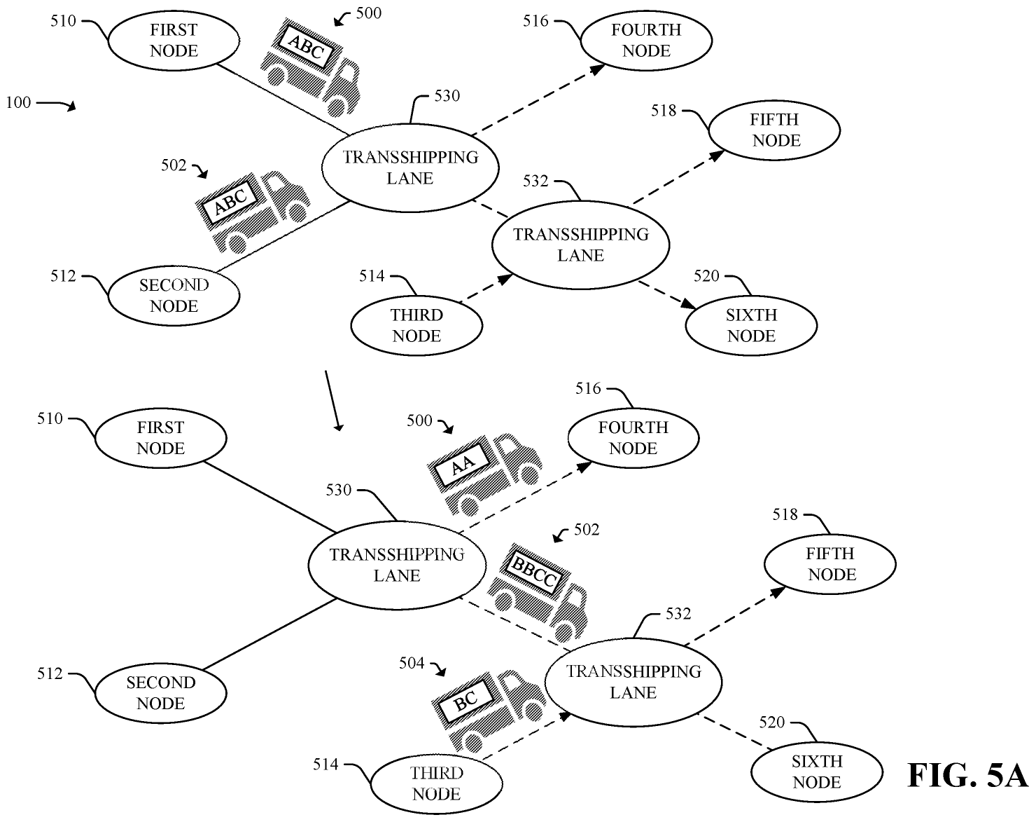

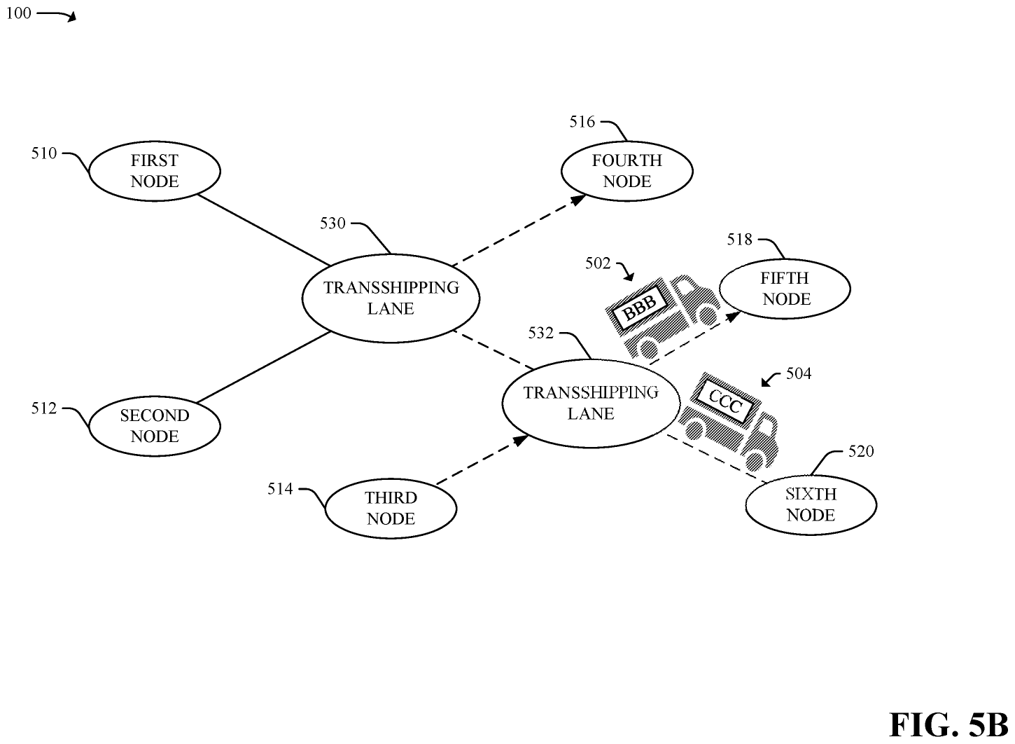

Turning to FIGS. 5A and 5B, a first node 510, a second node 512, a third node 514, a fourth node 516, a fifth node 518, and a sixth node 520 can be identified as locations for packages to be delivered by vehicles of vehicle network of the system 100. For example and without limitation, the vehicle network can include a first vehicle 500, a second vehicle 502, and a third vehicle 504. The first vehicle 500 can include one or more packages with delivery destinations at the fourth node 516 (e.g., “A” packages”); one or more packages with delivery destinations at the fifth node 518 (e.g., “B” packages); and one or more packages with delivery destinations at the sixth node 520 (e.g., “C” packages). The lane definition component 104 can determine/calculate an optimal location for a first temporary lane 530 (e.g., a first transshipping lane) to facilitate the exchange of packages between the first vehicle 500 and the second vehicle 502. The first temporary lane 530 can be in a location of the road where a planned route for the first vehicle 500 intersects/overlaps with a planned route for the second vehicle 502.

With embodiments, in the first temporary lane 530, the first vehicle 500 can exchange one or more packages with the second vehicle 502 such that packages to be delivered at the fourth node 516 (e.g., “A” packages) are included in the first vehicle 500. As a result, the second vehicle 502 can include one or more packages to be delivered at the fifth node 518 (e.g., “B” packages) and at the sixth node 520 (e.g., “C” packages). The first vehicle 500 can proceed to deliver one or more packages to the fourth node 516. The lane definition component can determine/calculate an optimal location for a second temporary lane 532 (e.g., a second transshipping lane) to facilitate the exchange of packages between the second vehicle 502 and the third vehicle 504. The second temporary lane 532 can be in a location of the road where a planned route of the second vehicle 502 intersects/overlaps with a planned route for the third vehicle 504.

In embodiments, in the second temporary lane 532, the second vehicle 502 can exchange one or more packages with the third vehicle 504 such that packages to be delivered at the fifth node 518 (e.g., “B” packages) are included in the second vehicle 502. As a result, the third vehicle 504 can include one or more packages to be delivered at the sixth node 520 (e.g., “C” packages). The second vehicle 502 can proceed to deliver one or more packages to the fifth node 518, and the third vehicle 504 can proceed to deliver one or more packages to the sixth node 520. In one or more examples, any number of additional nodes, vehicles, and/or temporary lanes (transshipping lanes) can be included in the system 100.

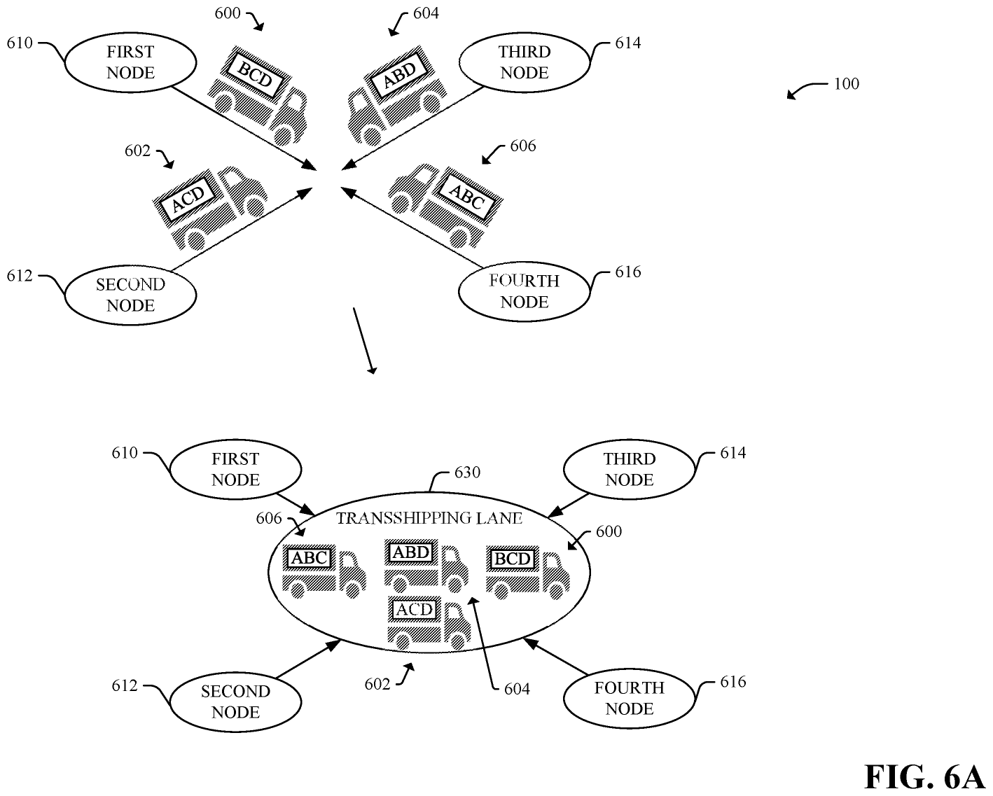

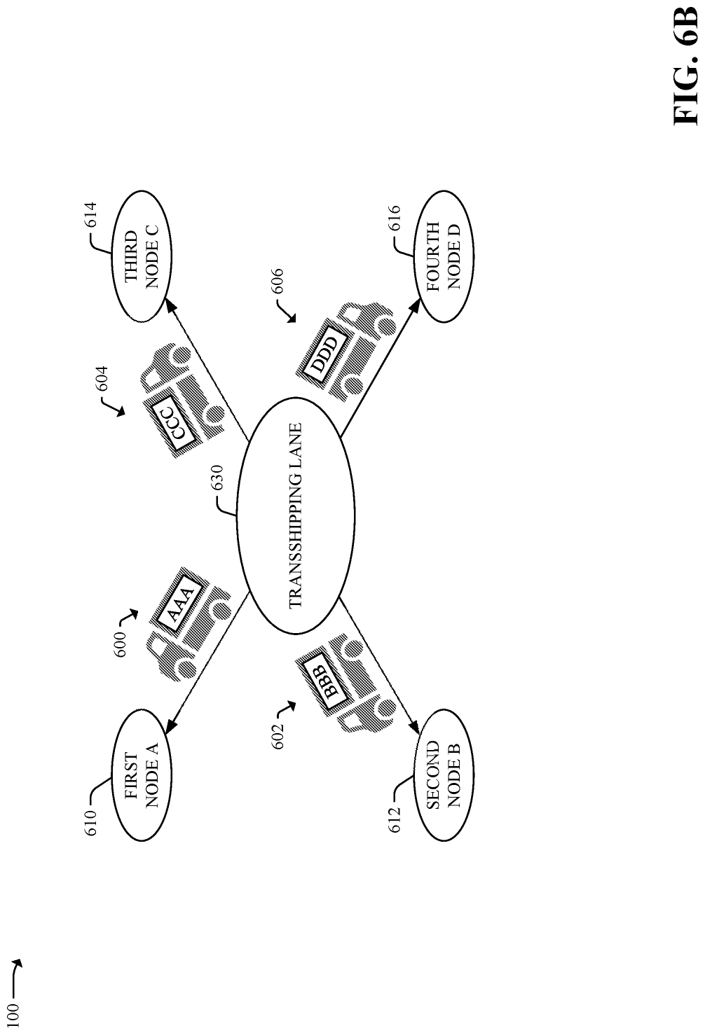

Turning next to FIGS. 6A and 6B, the temporary lane transshipment system 100 can include a vehicle network that includes a first vehicle 600, a second vehicle 602, a third vehicle 604, and a fourth vehicle 606. The temporary lane transshipment system 100 can identify a first node 610, a second node 612, a third node 614, and a fourth node 616 associated with delivery addresses/locations for one or more packages. As can be seen in FIG. 6A, the first vehicle 600 can include one or more packages to be delivered at the second node 612 (e.g., “B” packages), the third node 614 (e.g., “C” packages), and the fourth node 616 (e.g., “D” packages). The second vehicle 602 can include one or more packages to be delivered at the first node 610 (e.g., “A” packages), the third node 614 (e.g., “C” packages), and the fourth node 616 (e.g., “D” packages). The third vehicle 604 can include one or more packages to be delivered at the first node 610 (e.g., “A” packages), the second node 612 (e.g., “B” packages), and the fourth node 616 (e.g., “D” packages). The fourth vehicle 606 can include one or more packages to be delivered at the first node 610 (e.g., “A” packages), the second node 612 (e.g., “B” packages), and the third node 614 (e.g., “C” packages). The first vehicle 600 can depart from the first node 610, the second vehicle 602 can depart from the second node 612, the third vehicle 604 can depart from the third node 614, and the fourth vehicle 606 can depart from the fourth node 616.

In embodiments, the lane definition component 104 can determine/calculate an optimal location for a temporary lane 630 (e.g., a transshipping lane) to facilitate the exchange of one or more packages between the first vehicle 600, the second vehicle 602, the third vehicle 604, and the fourth vehicle 606 (e.g., or any number of vehicles or any number of nodes). The temporary lane 630 can be in a location of the road (e.g., or any other location on a vehicle, road, or warehouse) where planned routes of the first vehicle 600, the second vehicle 602, the third vehicle 604, and the fourth vehicle 606 interest/overlap. Alternatively, if there are no intersecting or overlapping portions, the temporary lane 630 can be in a location most proximate to the planned routes (e.g., where nodes can be equidistant from the temporary lane 630). In response to determining the temporary lane 630, the first vehicle 600, the second vehicle 602, the third vehicle 604, and the fourth vehicle 606 can travel to the temporary lane 630 for the exchange of packages.

With embodiments, in response to arriving at the temporary lane 630, packages can be exchanged such that the first vehicle 600 includes one or more packages to be delivered at the first node 610 (e.g., “A” packages); the second vehicle 602 includes one or more packages to be delivered at the second node 612 (e.g., “B” packages); the third vehicle 604 includes one or more packages to be delivered at the third node 614 (e.g., “C” packages); and the fourth vehicle 606 includes one or more packages to be delivered at the fourth node 616 (e.g., “D” packages). Following, the first vehicle 600 can depart for the first node 610 to deliver “A” packages to the first node 610; the second vehicle 602 can depart for the second node 612 to deliver “B” packages to the second node 612; the third vehicle 604 can depart for the third node 614 to deliver “C” packages to the third node 614; and the fourth vehicle 606 can depart for the fourth node 616 to deliver “D” packages to the fourth node 616.

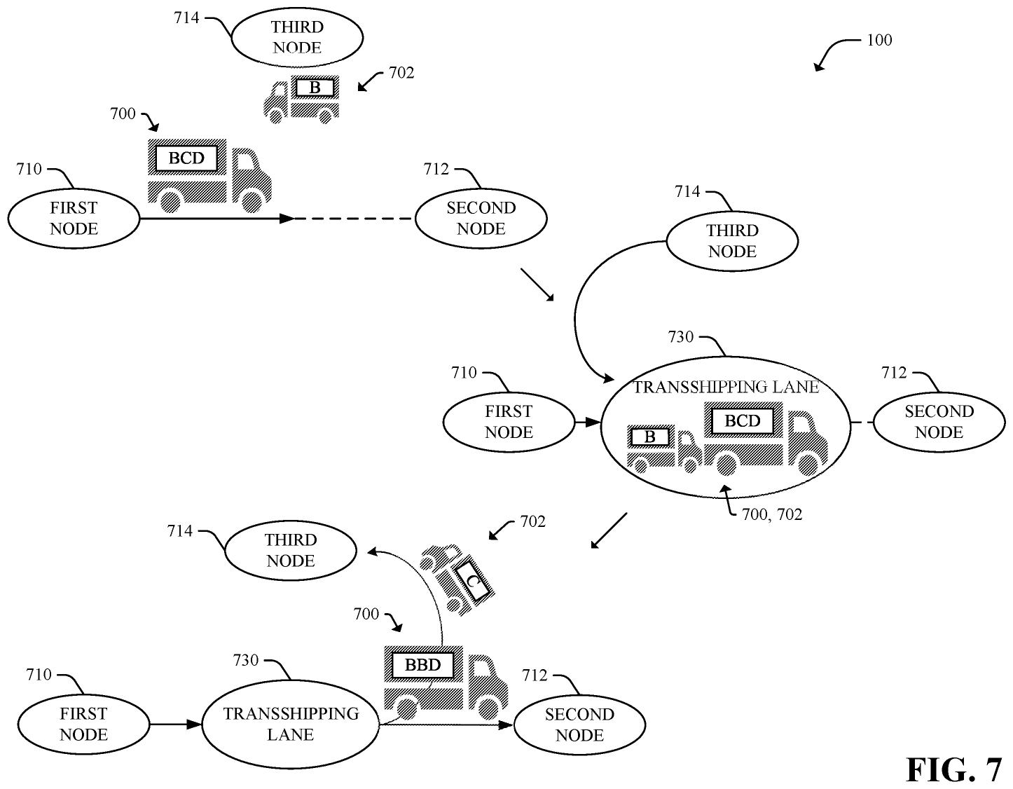

Turning next to FIG. 7, the temporary lane transshipment system 100 can include a vehicle network including a first vehicle 700 and a second vehicle 702. The first vehicle 700 can be configured to travel generally long distances and/or at high speeds (e.g., along a highway). The first vehicle 700 can travel from a first node 710 to a second node 712 (e.g., which can be on a highway). The second vehicle 702 can depart from any location and can travel to arrive at a third node 714, which can be at a location substantially proximate the planned route of the first vehicle 700. In response to the second vehicle 702 arriving at the third node 714, the lane definition component 104 can determine/calculate a temporary lane 730 (e.g., a transshipping lane) for the first vehicle 700 and the second vehicle 702 to exchange packages, which can be located on the highway.

With embodiments, the first vehicle 700 can include one or more packages to be delivered at the second node 712 (e.g., “B” packages); one or more packages to be delivered at the third node 714 (e.g., “C” packages); and/or any other node (e.g., “D” packages). The second vehicle 702 can include one or more packages to be delivered at the second node 712 (e.g., “B” packages). The transshipping component can arrange a platoon formation, where the first vehicle 700 can be connected with the second vehicle 702 (e.g., while moving or stationary) in a side-by-side or front-to-back manner to exchange one or more packages. The first vehicle 700 can include one or more packages to be delivered at the second node 712 (e.g., “B” packages) and any other node (e.g., “D” packages); and the second vehicle 702 can include one or more packages to be delivered at the third node 714 (e.g., “C” packages). Further, the first vehicle 700 can depart for the second node 712 and the second vehicle 702 can depart for the third node 714. The lane definition component 104 can remove the temporary lane 730 from the road to allow for all vehicles to travel within the previously existing temporary lane.

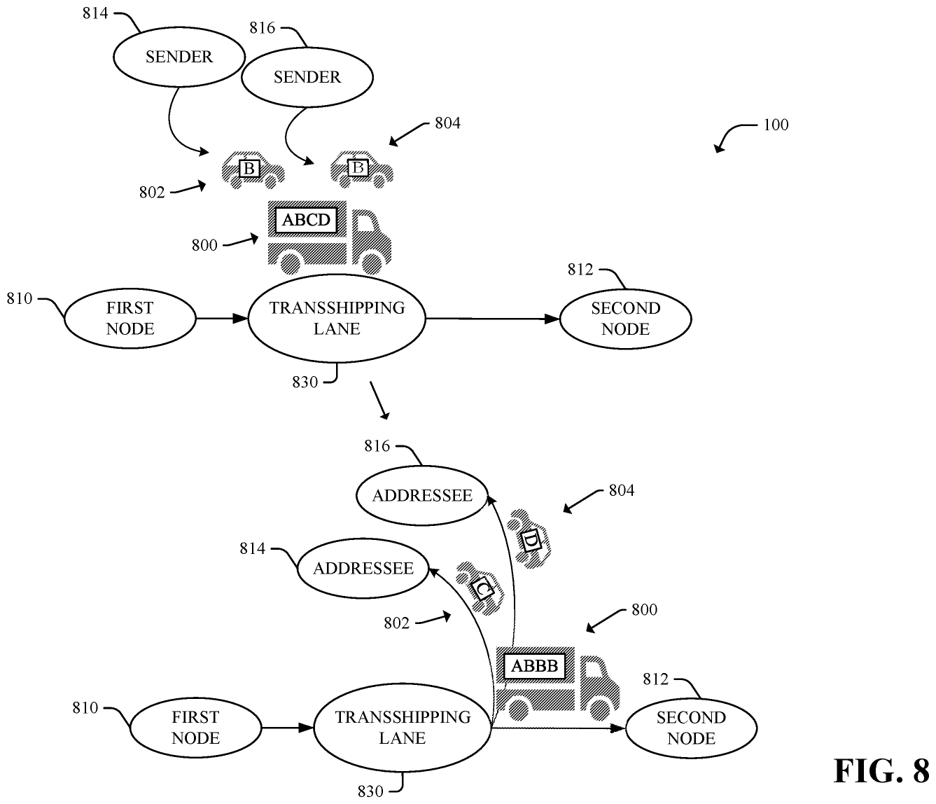

Turning next to FIG. 8, the temporary lane transshipment system 100 can include a vehicle network comprising a first vehicle 800, a second vehicle 802, and a third vehicle 804. The first vehicle 800 can be configured to travel from a first node 810 to a second node 812 (e.g., due to a planned route for the first vehicle 800). The second vehicle 802 and the third vehicle 804 can be passenger vehicles including one or more passengers and one/or more packages to be delivered at the second node 812 (e.g., “B” packages), or any other node within the system 100 connected with the second node 812. The second vehicle 802 can depart from a third node 814 (e.g., a sender node) and the third vehicle 804 can depart from a fourth node 816 (e.g., a sender node). For example and without limitation, the third node 814 and the fourth node 816 can be home addresses. The first vehicle 800 can include one or more packages to be delivered at the second node 812 (e.g., “B” packages), the third node 814 (e.g., “C” packages), the fourth node 816 (e.g., “D” packages), and/or any other node connected with the system 100 (e.g., “A” packages). The lane definition component 104 can determine/calculate a temporary lane 830 (e.g., a transshipping lane) for the second vehicle 802 and the third vehicle 804 to exchange packages. In response to the transshipment component 106 transferring one or more packages in the temporary lane 830 between the first vehicle 800, the second vehicle 802, and the third vehicle 804, the first vehicle 800 can include one or more packages to be delivered at the second node 812 (e.g., “B” packages and/or any other node in the system 100 (e.g., “A” packages); the second vehicle 802 can include one or more packages to be delivered at the third node 814 (e.g., “C” packages); and the third vehicle 804 can include one or more packages to be delivered at the fourth node 816 (e.g., “D” packages). The transshipment component 106 can exchange one or more packages while the first vehicle 800, the second vehicle 802, and the third vehicle 804 are stationary or in motion.

In embodiments, the first vehicle 800 can continue to travel to the second node 812 and/or any other node within the system 100; the second vehicle 802 can return to the third node 814 (e.g., which can be an address); and the third vehicle 804 can return to the fourth node 816 (e.g., which can be an address). In response to the first vehicle 800, the second vehicle 802, and the third vehicle 804 exiting the temporary lane 830, the temporary lane 830 can be removed such that all vehicles (e.g., the general public) can travel in the previously-existing temporary lane.

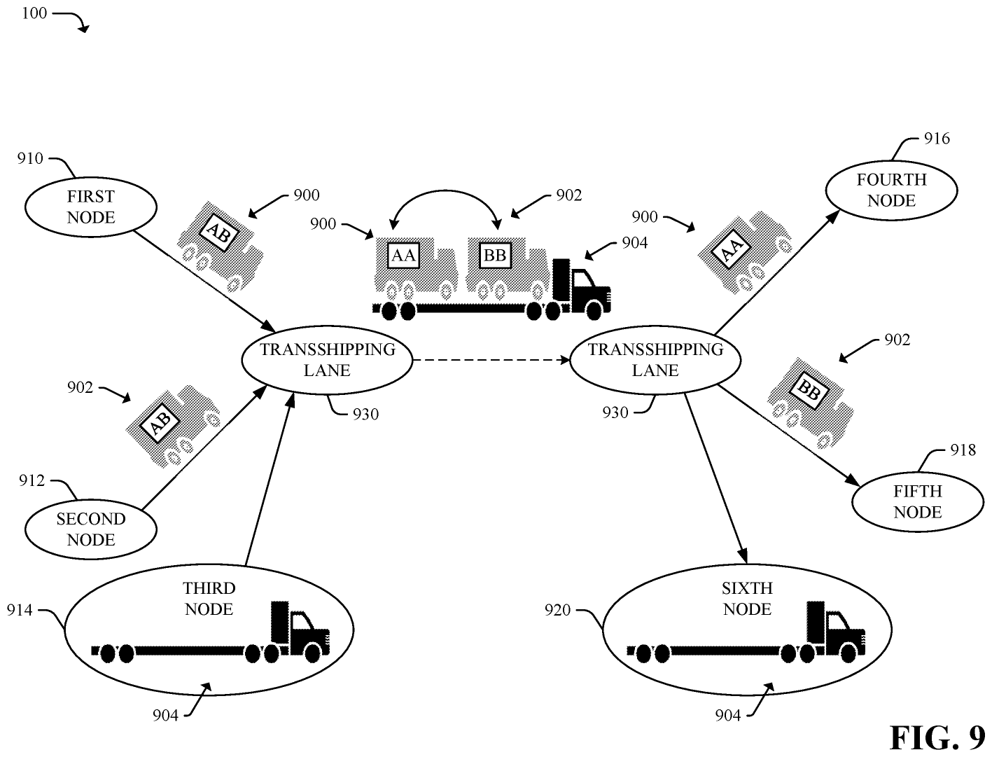

With embodiments, such as generally illustrated in FIG. 9, the temporary lane transshipment system 100 can include a first vehicle 900, a second vehicle 902, and a third vehicle 904. The first vehicle 900 can depart from a first node 910 and can include one or more packages to be delivered at a fourth node 916 (e.g., “A” packages) and one or more packages to be delivered at a fifth node 918 (e.g., “B” packages). The second vehicle 902 can depart from a second node 912 and can include one or more packages to be delivered at a fourth node 916 (e.g., “A” packages) and one or more packages to be delivered at a fifth node 918 (e.g., “B” packages). The third vehicle 904 can depart from a third node 914, and the third vehicle can be a carrier vehicle configured to transport the first vehicle 900 and the second vehicle 902. The third node 914 can be associated with a carrier vehicle distribution warehouse, or the third node 914 can be a location that which the carrier vehicle is parked at. The lane definition component 104 can determine/calculate a temporary lane 930 (e.g., a transshipping lane) for the first vehicle 900 and the second vehicle 902 to be received (e.g., loaded and transported) by the third vehicle 904. While the third vehicle 904 transports the first vehicle 900 and the second vehicle 902, the transshipment component 106 can exchange packages between the first vehicle 900 and the second vehicle 902. Such as shown in FIG. 9, the transshipment component 106 can exchange one or more packages such that the first vehicle 900 includes one or more packages to be delivered at the fourth node 916 (e.g., “A” packages) and the second vehicle 902 includes one or more packages to be delivered at the fifth node 918 (e.g., “B” packages). In other words, the packages on the first vehicle 900 to be delivered to the fifth node 918 can be moved from the first vehicle 900 to the second vehicle 902 for delivery; and the packages on the second vehicle 902 to be delivered to the fourth node 916 can be moved from the second vehicle 902 to the first vehicle 900 for delivery.

In embodiments, in response to the packages being exchanged, the first vehicle 900, the second vehicle 902, and the third vehicle 904 can exit the temporary lane 930, and the lane definition component 104 can remove the temporary lane 930 such that all vehicles (e.g., including the general public) can traverse the previously-existing temporary lane. The first vehicle 900 can deliver the one or more packages to the fourth node 916 (e.g., “A” packages); the second vehicle 902 can deliver the one or more packages to the fifth node 918 (e.g., “B” packages); and the third vehicle 904 can travel to a sixth node 920, which can be a storage location for carrier vehicles and/or a warehouse.

With further examples, a railroad car can be used as an alternative to the carrier vehicle such that the first vehicle 900 and the second vehicle 902 can be loaded onto the temporary lane, which can be a portion of a railroad that which a train car can receive the first vehicle 900 and the second vehicle 902.

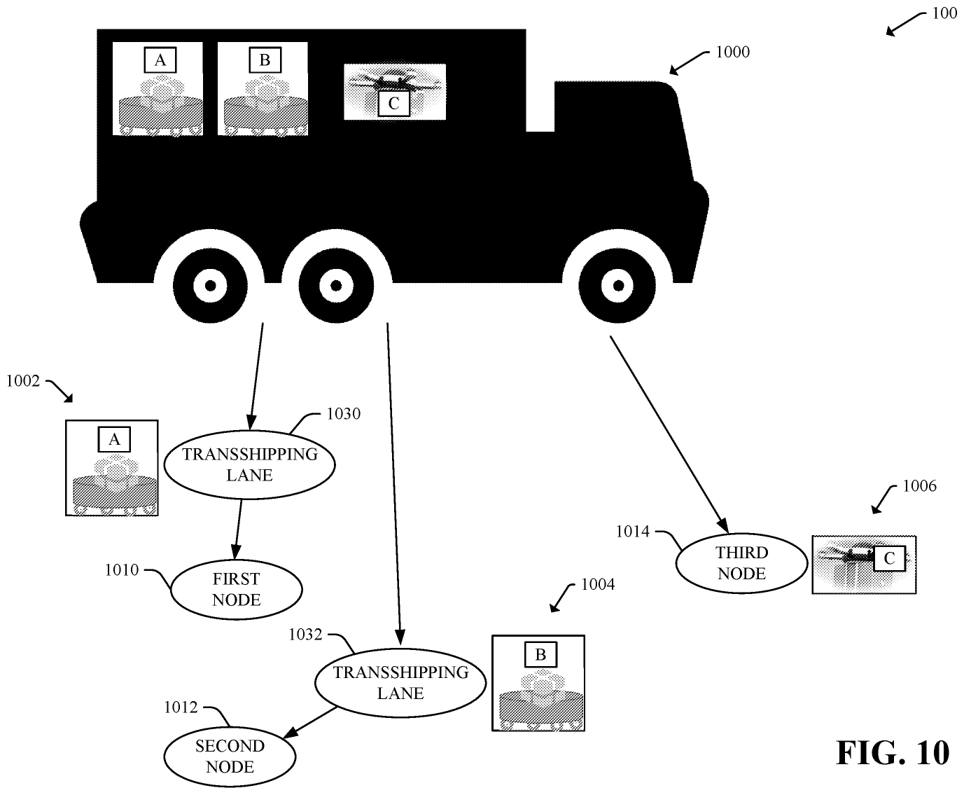

Turning next to FIG. 10, the temporary lane transshipment system 100 can include a first vehicle 1000, a second vehicle 1002, a third vehicle 1004, and a fourth vehicle 1006. The first vehicle 1000 can be configured to receive the second vehicle 1002, the third vehicle 1004, and the fourth vehicle 1006 (e.g., or any number of vehicles). The second vehicle 1002 and/or the third vehicle 1004 can be one or more of a variety of autonomous land vehicles configured to autonomously navigate to a first node 1010, a second node 1012, an/or a third node 1014. The second vehicle 1002 can be carrying one or more packages to be delivered at the first node 1010 (e.g., “A” packages), and the third vehicle 1004 can be carrying one or more packages to be delivered at the second node 1012 (e.g., “B” packages). Additionally, the fourth vehicle 1006 can be one or more of a variety of autonomous air vehicles (e.g., drones) and can include one or more packages to be delivered at the third node 1014. Further, the transshipment component 106 can move packages (e.g., to be delivered to the first node 1010) from the third vehicle 1004 and the fourth vehicle 1006 to the second vehicle 1002. The transshipment component 106 can move packages (e.g., to be delivered to the second node) from the second vehicle 1002 and the fourth vehicle 1006 to the third vehicle 1004. Additionally, the transshipment component 106 can move packages (e.g., to be delivered to the third node 1014) from the second vehicle 1002 and the third vehicle 1004 to the fourth vehicle 1006.

With embodiments, the lane definition component 104 can determine/calculate a first temporary lane 1030 (e.g., a transshipping lane) for the second vehicle 1002 to travel and/or exchange packages with an additional vehicle before reaching the first node 1010. In a similar manner, the lane definition component 104 can determine/calculate a second temporary lane 1032 (e.g., a transshipping lane) for the third vehicle 1004 to travel and/or exchange packages with an additional vehicle before reaching the second node 1012.

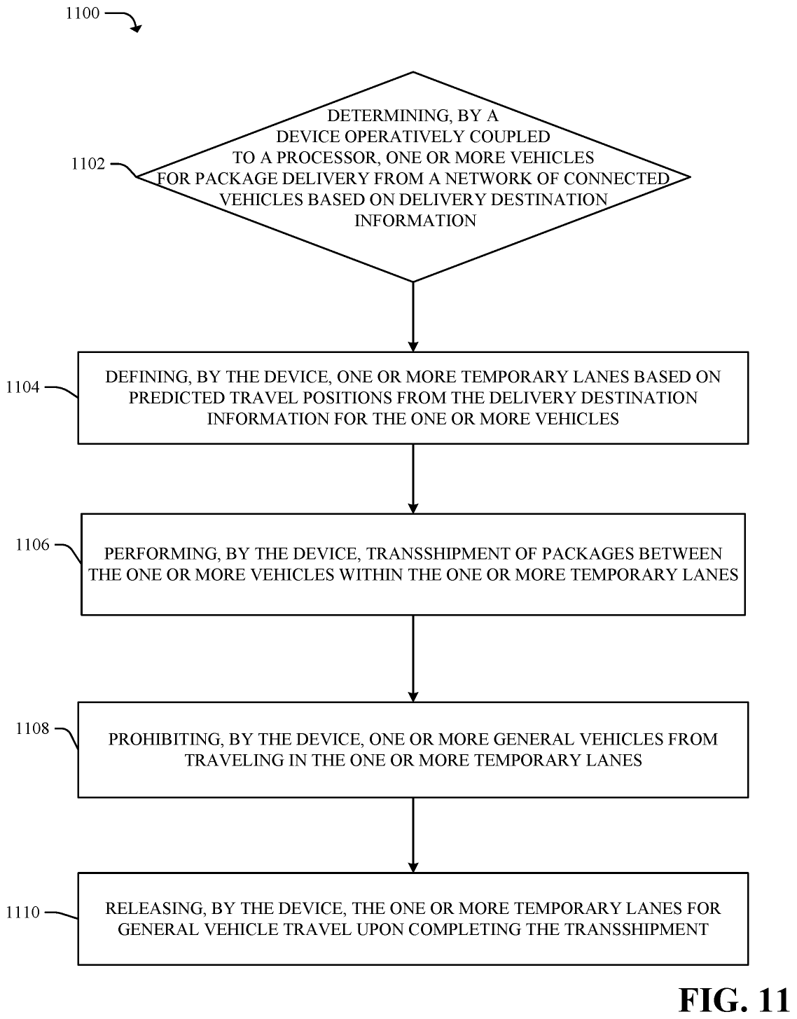

With embodiments, FIG. 11 illustrates a flow diagram of an example, non-limiting computer implemented method 1100 that can facilitate locating temporary distribution lanes on a road for transshipment in accordance with one or more embodiments described herein. Repetitive descriptions of like elements and/or processes employed in respective embodiments is omitted for sake of brevity.

At 1102, the computer implemented method 1100 can comprise determining, by a device (e.g., a vehicle network component 102, a lane definition component 104, and a transshipment component 106) operatively coupled to a processor, one or more vehicles for package delivery from a network of connected vehicles based on delivery destination information.

At 1104, the computer implemented method 1100 can comprise defining, by the device (e.g., a vehicle network component 102, a lane definition component 104, and a transshipment component 106) operatively coupled to a processor, one or more temporary lanes based on predicted travel positions from the delivery destination information for the one or more vehicles.

At 1106, the computer implemented method 1100 can comprise performing, by the device (e.g., a vehicle network component 102, a lane definition component 104, and a transshipment component 106) operatively coupled to a processor, transshipment of packages between the one or more vehicles within the one or more temporary lanes.

At 1108, the computer implemented method 1100 can comprise prohibiting, by the device (e.g., a vehicle network component 102, a lane definition component 104, and a transshipment component 106) operatively coupled to a processor, one or more general vehicles from traveling in the one or more temporary lanes.

At 1110, the computer implemented method 1100 can comprise releasing, by the device (e.g., a vehicle network component 102, a lane definition component 104, and a transshipment component 106) operatively coupled to a processor, the one or more temporary lanes for general vehicle travel upon completing the transshipment.

With embodiments, at 1112, the computer implemented method 1100 (e.g., step 1104) can further comprise dynamically allocating, by the device (e.g., a vehicle network component 102, a lane definition component 104, and a transshipment component 106), the one or more temporary lanes for the one or more vehicles to transfer packages therebetween.

At 1114, the computer implemented method 1100 (e.g., step 1104) can further comprise defining, by the device (e.g., a vehicle network component 102, a lane definition component 104, and a transshipment component 106), the one or more temporary lanes where a first planned route of a first vehicle, having one or more first packages corresponding to a first delivery address and one or more second packages corresponding to a second delivery address, overlaps with a second planned route of a second vehicle, having one or more third packages corresponding to the first delivery address and one or more fourth packages corresponding to the second delivery address, to facilitate the exchange of packages during transshipment.

In embodiments, at 1116, the computer implemented method 1100 (e.g., step 1106) can further comprise moving, by the device, the one or more third packages from the second vehicle to the first vehicle; and moving, by the device, the one or more second packages from the first vehicle to the second vehicle, wherein the first vehicle travels to the first delivery address and the second vehicle travels to the second delivery address

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively mitigate the prorogation of errors from the generative stage to the parser training stage as the one or more embodiments described herein can enable this process. And, neither can the human mind nor a human with pen and paper mitigate the propagation of errors from the generative stage to the parser training stage, as conducted by one or more embodiments described herein.

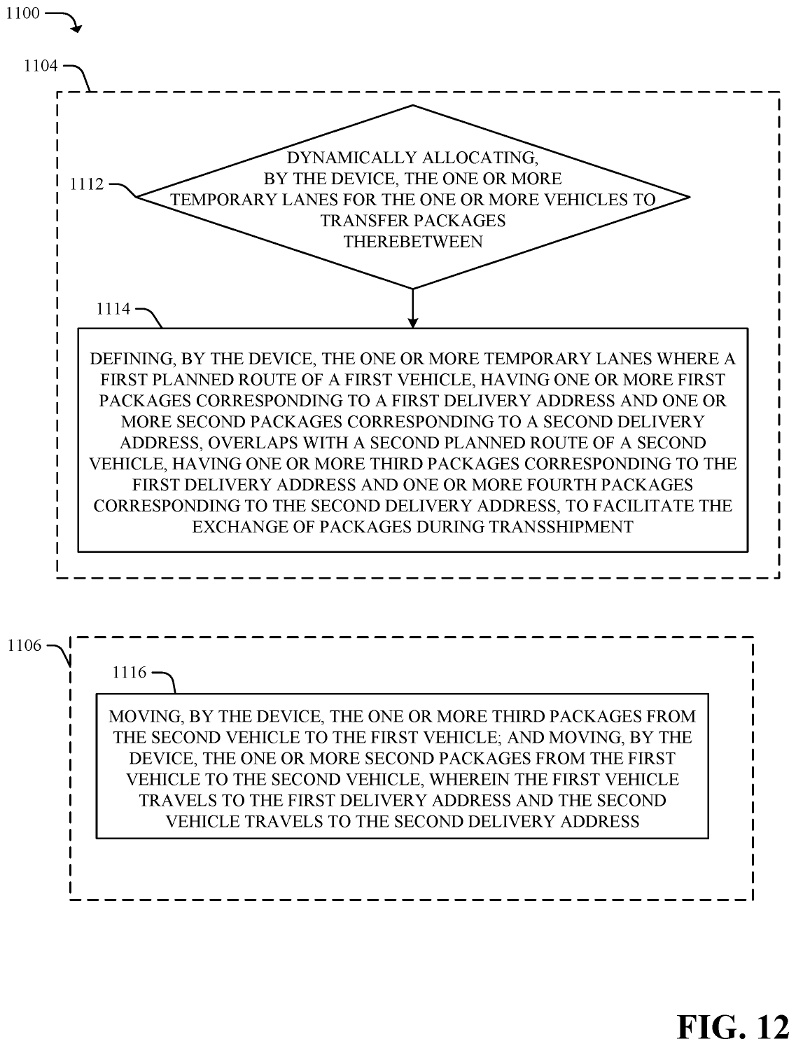

FIG. 13 illustrates a block diagram of an example, non-limiting operating environment 1300 in which one or more embodiments described herein can be facilitated. FIG. 13 and the following discussion are intended to provide a general description of a suitable operating environment 1300 in which one or more embodiments described herein at FIGS. 1-12 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as locating temporary distribution lanes on a road for transshipping code block 1345. In addition to block 1345, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1345, as identified above), peripheral device set 1314 (including user interface (UI), device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1345 in persistent storage 1313.

COMMUNICATION FABRIC 1311 is the signal conduction paths that allow the various components of computer 1301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, the volatile memory is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface type operating systems that employ a kernel. The code included in block 1345 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer-executable components stored in a non-transitory computer-readable memory, wherein the computer-executable components comprise:
a vehicle network component that determines one or more vehicles for package delivery from a network of connected vehicles based on delivery destination information;
a lane definition component that defines one or more temporary lanes based on predicted travel positions from the delivery destination information for the one or more vehicles; and
a transshipment component that performs transshipment of packages between the one or more vehicles within the one or more temporary lanes,
wherein one or more general vehicles are prohibited from traveling in the one or more temporary lanes, and the one or more temporary lanes are released for general vehicle travel upon completing the transshipment.

2. The system of claim 1, wherein the lane definition component can dynamically allocate the one or more temporary lanes for the one or more vehicles to transfer packages therebetween.

3. The system of claim 2, wherein the one or more vehicles include:
a first vehicle having one or more first packages corresponding to a first delivery address and one or more second packages corresponding to a second delivery address, and
a second vehicle having one or more third packages corresponding to the first delivery address and one or more fourth packages corresponding to the second delivery address;
wherein the lane definition component defines a temporary lane where a first planned route of the first vehicle overlaps with a second planned route of the second vehicle to facilitate an exchange of packages during transshipment.

4. The system of claim 3, wherein the transshipment component moves the one or more third packages to the first vehicle; and the transshipment component moves the one or more second packages to the second vehicle.

5. The system of claim 4, wherein the first vehicle travels to the first delivery address and the second vehicle travels to the second delivery address.

6. The system of claim 5, wherein the first delivery address or the second delivery address is another temporary lane for further transshipment.

7. The system of claim 3, wherein the first vehicle or the second vehicle is an autonomous vehicle.

8. A computer implemented method for locating temporary distribution lanes on a road for transshipment, the computer implemented method comprising:
determining, by a device operatively coupled to a processor, one or more vehicles for package delivery from a network of connected vehicles based on delivery destination information;
defining, by the device, one or more temporary lanes based on predicted travel positions from the delivery destination information for the one or more vehicles;
performing, by the device, transshipment of packages between the one or more vehicles within the one or more temporary lanes;
prohibiting, by the device, one or more general vehicles from traveling in the one or more temporary lanes; and
releasing, by the device, the one or more temporary lanes for general vehicle travel upon completing the transshipment.

9. The computer implemented method of claim 8, further comprising:
dynamically allocating, by the device, the one or more temporary lanes for the one or more vehicles to exclusively travel and transfer packages therebetween.

10. The computer implemented method of claim 9, further comprising:
defining, by the device, the one or more temporary lanes where a first planned route of a first vehicle, having one or more first packages corresponding to a first delivery address and one or more second packages corresponding to a second delivery address, overlaps with a second planned route of a second vehicle, having one or more third packages corresponding to the first delivery address and one or more fourth packages corresponding to the second delivery address, to facilitate an exchange of packages during transshipment.

11. The computer implemented method of claim 10, further comprising:
moving, by the device, the one or more third packages from the second vehicle to the first vehicle; and
moving, by the device, the one or more second packages from the first vehicle to the second vehicle,
wherein the first vehicle travels to the first delivery address and the second vehicle travels to the second delivery address.

12. The computer implemented method of claim 11, wherein the first delivery address or the second delivery address is another temporary lane for further transshipment.

13. The computer implemented method of claim 10, wherein the first vehicle or the second vehicle is an autonomous vehicle.

14. A computer program product for locating temporary distribution lanes on a road for transshipment, the computer program product comprising a non-transitory computer readable memory having program instructions embodied therewith, the program instructions executable by a processor to cause the processor to:
determine one or more vehicles for package delivery from a network of connected vehicles based on delivery destination information;
define one or more temporary lanes based on predicted travel positions from the delivery destination information for the one or more vehicles;
perform transshipment of packages between the one or more vehicles within the one or more temporary lanes;
prohibit one or more general vehicles from traveling in the one or more temporary lanes; and
release the one or more temporary lanes for general vehicle travel upon completing the transshipment.

15. The computer program product of claim 14, wherein the program instructions are further executable to cause the processor to:
dynamically allocate the one or more temporary lanes for the one or more vehicles to exclusively travel and transfer packages therebetween.

16. The computer program product of claim 15, wherein the program instructions are further executable to cause the processor to:
define the one or more temporary lanes where a first planned route of a first vehicle, having one or more first packages corresponding to a first delivery address and one or more second packages corresponding to a second delivery address, overlaps with a second planned route of a second vehicle, having one or more third packages corresponding to the first delivery address and one or more fourth packages corresponding to the second delivery address, to facilitate an exchange of packages during transshipment.

17. The computer program product of claim 16, wherein the program instructions are further executable to cause the processor to:
move the one or more third packages from the second vehicle to the first vehicle; and
move the one or more second packages from the first vehicle to the second vehicle.

18. The computer program product of claim 17, wherein the first vehicle travels to the first delivery address and the second vehicle travels to the second delivery address.

19. The computer program product of claim 16, wherein the first delivery address or the second delivery address is another temporary lane for further transshipment.

20. The computer program product of claim 16, wherein the first vehicle or the second vehicle is an autonomous vehicle.
